(19) United States
(12) Patent Application Publication
(10) Pub. No.: US 2011/0168335 A1
(43) Pub. Date: Jul. 14, 2011

(54) Mobile Partition

(76) Inventor: Harald Hoopmann, Westerstede (DE)

(21) Appl. No.: 13/061,828

(22) PCT Filed: Aug. 31, 2009
(86) PCT No.: PCT/EP09/06285

§ 371 Date: Mar. 2, 2011

(51) Int. Cl. E04B 2/74; E05F 15/20

(52) U.S. Cl. 160/1; 160/351

(57) ABSTRACT

A mobile partitioning wall including a plurality of independently displaceable wall elements. Each wall element has vertically movable connecting profiles and a control unit to control at least one drive of the connecting profiles. In a braced position the connecting profiles are braced between the floor and the ceiling, and in an open position, the connecting profiles are disposed at the wall element. When unlocking the mobile partitioning wall the wall elements are sequentially transferable from the bracing position into the open position. The control units are connected in parallel to an electrical voltage source in such that, in the braced position the control units are charged with a working voltage. A signal element is able to transmit a first unlocking signal for unlocking a first wall element and after unlocking a first wall element the signal element generates a second unlocking signal for a second wall element.

### PRIORITY CLAIM

This is a U.S. national stage of Application No. PCT/EP2009/006285, filed on Aug. 31, 2009, which claims priority to German Application No: 10 2008 045 519.9, filed: Sep. 3, 2008, the contents of which are incorporated herein by reference.

### BACKGROUND OF THE INVENTION

1. Field of the Invention

The invention relates to a mobile partitioning wall, including a plurality of independently displaceable wall elements and to a method for unlocking a plurality of wall elements of a mobile portioning wall. Each wall element has vertically movable connecting profiles and each wall element has a control unit to control at least one drive of the connecting profiles. In a braced position, the connecting profiles are braced between the floor and the ceiling, and in an open position, the connecting profiles are disposed at the wall element. When unlocking the mobile partitioning wall, the wall elements are sequentially transferable from the braced position into the open position to a method for unlocking a plurality of wall elements of a mobile partitioning wall

2. Related Art

Mobile partitioning walls of the described species primarily serve to allow for subdividing larger rooms. Likewise, in shopping centres or in shopping arcades, business premises can be separated by partitioning walls from a passage area. Generally, such mobile partitioning walls have a plurality of individually displaceable wall elements. In this case, the individual wall elements are generally made from closed panelling, which may consist for example of wood, metal, or glass. For forming the mobile partitioning wall, the wall elements are set up in a row parallel to each other and they are braced between the floor and the ceiling by connecting profiles. For this purpose, each wall element has connecting profiles in the upper and lower areas, which profiles, by a mechanical system, are pushed out of the wall element and against the floor and the ceiling. A motor may be utilized for bracing the connecting profiles. In order to guarantee a voltage supply to the drives, known mobile partitioning walls have plug-in devices at both lateral sides of the wall elements. The plug-in elements engage with each other such that an electrical connection is established by all the wall elements of the mobile partitioning wall. It is via this electrical connection that a voltage is applied to the first wall element, which thereby retracts the connecting profiles. If the drive has completely retracted the connecting profiles into the wall element, this position is registered for example by a limit switch. A signal of the limit switch is registered by a relay of a following wall element, which subsequently advances the voltage to a control unit of said element. As a consequence, the control units are sequentially supplied with voltage. In order to ensure this sequence, the electrical connection in each wall element has a relay. It has proven to be disadvantageous that the relays cause an important voltage drop, which limits the number of wall elements to be supplied by one voltage source.

### SUMMARY OF THE INVENTION

It is an object of one embodiment of the invention to develop a mobile partitioning wall with a plurality of individually displaceable wall elements, which overcomes the above-mentioned disadvantages. Features and details, which are described in conjunction with one or more embodiments of the inventive method, are obviously valid in conjunction with the inventive mobile partitioning wall and vice versa. In this context, the features, mentioned in the claims and in the description, may be individually or in random combination essential to the invention.

The core idea of one embodiment of the inventive mobile partitioning wall, as well as of the inventive method, is to separate the voltage supply of the individual control units from the signalization for activating the control units and/or the individual motors of the wall elements. If the mobile partitioning wall is in a closed position, all wall elements are located next to each other. In this case, each wall element is located in a braced position in which the connecting profiles are braced between the floor and the ceiling. If the mobile partitioning wall is to be transferred into an open position, a corresponding signal is triggered at a switch unit. This signal will result in supplying the control units of all wall elements with electrical voltage. For this purpose, the control units of the wall elements are interconnected in parallel. In addition to this electrical interconnection, one signal element is disposed in each wall element, wherein all signal elements of the different wall elements are in contact with each other. By triggering the signal at the control unit, a first unlocking signal is generated for a first wall element—generally a wall element at one of the end sides of the mobile partitioning wall. This first unlocking signal ensures that the first wall element passes from a braced position into an open position, in which the connecting profiles are no longer braced between the ceiling and the floor. Following the transition from the braced position into the open position—namely unlocking the first wall element—a second unlocking signal is produced for a second wall element. In this case, the second wall element is often disposed adjacent the first wall element. The inventive parallel activation of the control units allows a single voltage source to feed a plurality of control units. The relays, qualified as disadvantageous in the state-of-the-art, are omitted, because signalizing and activating the control units is no longer ensured via the voltage supply. It is rather a separately disposed signal element, which serves for this purpose.

An advantageous embodiment variant is distinguished in that the signal element has at least one pin-and-socket connection. The pin-and-socket connection serves to connect signal elements of different wall element to each other. It has proven to be advantageous if this pin-and-socket connection is disposed at an exterior side of the wall element. In the closed position, the wall elements of the mobile partitioning wall are set up such as to form one flat surface. Consequently, the exterior sides of two wall elements bear against each other. A pin-and-socket connection in one exterior side of a first wall element can thus serve for communicating with the signal element of a second wall element. In this case, it has proven to be particularly advantageous, if the signal element has at least one pin element, wherein the pin element of a first wall element cooperates with a pin-and-socket connection of a second wall element. Advantageously, the cooperation may be realized in particular non-positively and/or positively. The pin element, like a plug, is thus introduced into the pin-and-socket connection and produces thereby a continuous communication connection between both signal elements of the two wall elements. A communication interface thus disposed at the exterior sides of the wall elements has the advantage of not being exposed to environmental influences, because the exterior sides bear against each other in such a way that environmental influences, such as penetrating humidity etc., are not able to happen.

In each wall element, the described inventive mobile partitioning wall has at least one drive, which serves to displace the connecting profiles. In the braced position, the connecting profiles are pushed against the ceiling and the floor to position the wall element and to produce a continuous partitioning wall from the individual wall elements. As the wall elements, in the open position, are to be moved via a roller rail, the connecting profiles, in the open position, need to be retracted from the floor and the ceiling. The at least one drive serves for this purpose and ensures displacing the connecting profiles via a transmission. In an advantageous embodiment variant, it is intended for the control unit of the mobile partitioning wall to have a detector element to detect activity of the drive. In this case, the term activity is to be understood in the context of the invention that the detector element recognizes when the drive is moving, respectively when the connecting profiles are displaced by the drive. The control unit thus recognizes whether or not the drive needs to be further supplied with electrical power. The detector element may be for example a limit switch, which is disposed at a suitable position and monitors the position of the connecting profiles. As an alternative, likewise the current, supplied to the drive, may be monitored by the detector element. In a particularly advantageous embodiment it is intended that the control unit and/or the signal element and/or the detector element analyze a commutator malfunction of the drive. Commutator malfunctions are feedbacks that affect the voltage supply of the drives. In this case, these interference signals only occur as long as the drive is active.

In order to allow for a world-wide use of the mobile partitioning wall, in a further advantageous embodiment it is intended that the electrical voltage source consists of a wide-range input switched-mode power supply. Such a species of electrical voltage source can be operated at the most different voltages. Independently from the location of operation of the mobile partitioning wall, in the US—120 volts—or in Europe—230 volts—the control unit is always reliably and homogenously supplied. Therefore, the inventive mobile partitioning wall does not require any adaptation to the location of operation.

A further advantageous embodiment of the mobile partitioning wall is distinguished in that the control unit has a microcomputer. The microcomputer may be advantageously a programmable integrated circuit. Primarily the microcomputer serves to analyze the unlocking signals of the signal element and to convert them into corresponding commands to the drive of the connecting profiles. In this case, it has proven to be advantageous that the microcomputer is able to execute a software program. Thereby, only a single control unit with an extensively programmed microcomputer is required to control the most differently configured mobile partitioning walls. It is not required to change the hardware in the control unit depending on the location of operation of the mobile partitioning wall.

In particular for controlling the program in the microcomputer, it has proven to be advantageous if the control unit has a multiple switch, in particular a DIP-switch. By switching the multiple switch, it is thus possible to trigger program flows in the microcomputer, which are preset by hardware. The technician, who installs the mobile partitioning wall, is able to influence the control unit and/or the microcomputer by a corresponding selection at the multiple switch. Thereby, it is possible to effect a simple and efficient selection from the control cycles for the mobile partitioning wall.

The above mentioned problem is likewise solved by the inventive method for unlocking a plurality of wall elements of a mobile partitioning wall, wherein each wall element has vertically movable connecting profiles, a control unit and a signal element, the method including the following steps:
the control units of all wall elements are connected to an electrical voltage source, in order to charge the control units with a working voltage;
a first unlocking signal is transmitted to a first wall element via the signal elements of the wall elements,
the first unlocking signal triggers an activation of the control unit of the first wall element;
the control unit causes retracting the connecting profiles, which are braced between the floor and the ceiling; and
once retracting the first wall element is completed, a second unlocking signal is generated for a second wall element.

Features and details, which are described in conjunction with the inventive method, are obviously valid in conjunction with the inventive mobile partitioning wall and vice versa. Moreover, it should be noted that, once the first wall element is retracted, the previously second wall element becomes the now first wall element and the inventive method can run once more.

Another advantage of the inventive method is that the generation of second unlocking signal is triggered by a movement of the first wall element. On account of the first unlocking signal, the control unit has triggered the retraction of the braced connecting profiles. Consequently, the wall element, supported at the side of the ceiling, is movable and pivotable on a rail. On account of a movement of the first wall element in relation to the second wall element, the second wall element has the possibility to likewise retract the connecting profiles from the floor and from the ceiling. This action is triggered by the second unlocking signal. Advantageously, the two wall elements have the above described pin-and-socket connection and the above described pin element. When the first wall element moves in relation to the second wall element, the pin element is removed from the pin-and-socket connection. The signal element registers this release of the connection. The second unlocking signal is thereby generated.

Another advantageous step of the method is characterized in that locking a plurality of wall elements of the mobile partitioning wall is triggered by reversing the polarity of the working voltage. According to one embodiment of the invention, a method for unlocking a plurality of wall elements is described. The inventive method and the inventive mobile partitioning wall thus allow for an advantageous transition from the closed position into the open position. If the individual wall elements are then to be transferred back into the closed position, a first locking signal is triggered. At the same time, the polarity of the electrical voltage source is reversed compared to the unlocking scenario. If the first wall element is then transferred from a resting position into the position, in which later it is supposed to become a part of the mobile partitioning wall, the wall element reaches contact with the electrical voltage source via appropriate contact elements. The control unit registers the polarity of the voltage of the voltage source. The first locking signal is transmitted to the control unit via the signal element. This locking signal causes the connecting profiles to transfer from the open position into the braced position. Subsequently thereto, a second locking signal is generated by the signal element. This second locking signal is transmitted to a second wall element as soon as the latter has reached its final position in the mobile partitioning wall. Advantageously, the contacts both for transmitting the voltage and for the locking signal are disposed at the exterior sides of the wall elements. By the contact of the first wall element with the second wall element, the control unit of the second wall element is likewise supplied with voltage. In this case, the control units of both said wall elements are interconnected in parallel and are permanently charged with a voltage. Now, the second locking signal causes the control unit of the second wall element to likewise transfer the connecting profiles from the open position into the braced position. Thereupon, the method continues in that each time another wall element is added, it will automatically transfer the connecting profiles from the open position into the braced position and generate another locking signal for the following wall element. All control units are in this case permanently connected to the electrical voltage source.

Another advantageous method step is characterized in that an activity of the drive is monitored by the control unit, in particular by a sensor element of the control unit.

The transitions of the individual wall elements from the braced position into the open position are sequentially realized. This means, that once a transition of one wall element from the braced position into the open position is completed, only then the next wall element receives a corresponding unlocking signal in order to likewise release the connecting profiles from the ceiling and from the floor. In this case, it has proven to be advantageous, if each wall element has a mechanism for displacing the vertically movable connecting profiles. The mechanism may in particular have at least one limit switch registers if the connecting profile is moved into the braced position and/or open position. A corresponding signal may then be advanced to the control unit. It is likewise conceivable that the drive of the connecting profiles is monitored. If the drive still ensures a forward thrust to the connecting profiles, there is no need yet to generate another unlocking signal.

In order to ensure a homogenous and sequential activation of the provided drives in the wall elements, the drive activity needs to be monitored. In order to achieve this goal, it has proven to be particularly advantageous to monitor a commutator malfunction of the drive. By monitoring the commutator malfunction of the drive, it can be determined whether or not the drive still ensures the displacement of the connecting profiles or if these have already reached their predetermined positions. In this case, monitoring the commutator malfunction has proven to be particularly reliable and easy to realize.

It is furthermore preferred if the described mobile partitioning wall is operated according to one of the described methods.

Further measures improving the invention are indicated in the dependent claims or result from the following description of the embodiments of the invention, which are diagrammatically illustrated in the Figures. All features and/or advantages including the constructional details, spatial dispositions and method steps, resulting from the claims, the description or the drawings, may be essential to the invention, both by themselves and in the most various combinations.

### BRIEF DESCRIPTION OF DRAWINGS

In the drawings:

FIG. 1 is an inventive mobile partitioning wall;

FIG. 2 is a diagrammatical illustration of a plurality of control units of the inventive mobile partitioning wall;

FIG. 3 is an embodiment of the inventive control unit; and

FIG. 4 is an embodiment variant of the inventive control unit.

### DETAILED DESCRIPTION OF THE DRAWINGS

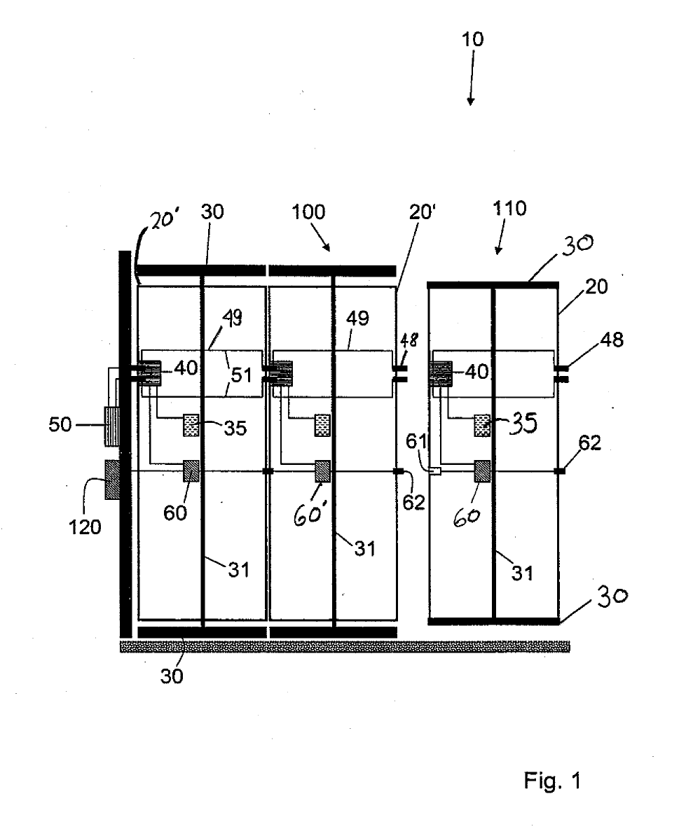

An inventive mobile partitioning wall 10 is illustrated in FIG. 1. This mobile partitioning wall 10 has a plurality of independently displaceable wall elements 20, 20′. The mobile partitioning wall 10 may be utilized to subdivide rooms etc. For this purpose, in a closed position, the wall elements 20, 20′ can be disposed parallel next to each other and then connected to each other. In an open position, the mobile partitioning wall 10 can be separated into the different wall elements 20, 20′, wherein it is possible to move each of the wall elements 20, 20′ individually into a parking position. For this purpose, a rail system, which is not illustrated in FIG. 1, may be disposed above the mobile partitioning wall 10 that serves to move the individual wall elements 20, 20′ out of their closed position.

Each wall element 20, 20′ of the mobile partitioning wall 10 has vertically movable connecting profiles 30 such that the wall elements 20, 20′ form a complete partitioning wall in the closed position. The connecting profiles 30 of each wall element 20, 20′ can be reversibly braced between the floor and the ceiling by a drive 35. For this purpose, it has proven to be advantageous if each wall element 20, 20′ has a mechanism 31 for displacing the vertically movable connecting profiles 30. Each wall element 20, 20′ can be transferred into a braced position 100 and an open position 110 by the vertically movable connecting profiles 30. In FIG. 1, the two wall elements 20′ disposed on the left hand side are respectively illustrated in the braced position 100. In this case, the connecting profiles 30 are braced between the floor and the ceiling. The wall element 20 shown on the right hand side is illustrated in the open position 110. In this case, the connecting profiles 30 are disposed at the wall element 20. It is thus guaranteed that the connecting profiles 30 do not contact the floor and the ceiling and that the wall element 20 can therefore be moved out of its closed position. It is thus possible to sequentially transfer the wall elements 20, 20′ of the mobile partitioning wall 10 into the open position and to displace them into a parking position which is facing away from the mobile partitioning wall.

During a transition from a closed position into an open position, generally at first the wall element 20, 20′, which is disposed the furthest away from an external voltage source 50, is transferred from the braced position 100 into the open position 110. In FIG. 1, the voltage source 50 is located at a wall on the left hand side of the drawing. Consequently, at first the wall element 20 is transferred to the open position 110 because it is furthest away from the electrical voltage source 50. Thus, a voltage supply of the drive 35 needs to be ensured by the remaining wall elements 20′. In the inventive mobile partitioning wall, a number of control units 40 are connected in parallel to the electrical voltage source 50 in such a way that, in the braced position 100, the control units 40 are charged with a working voltage. Each of the wall elements 20, 20′ has a control unit 40, to control at least one drive 35 of the connecting profiles.

All control units 40 of the mobile partitioning wall disposed in the closed position are connected to the electrical voltage source 50 in case it is planned to transfer the mobile partitioning wall 10 into the open position. Thus, there is no more sequential energizing of control units 40, as it is common in the state-of-the-art. Rather all control units 40 are immediately connected to the electrical voltage source 50 and charged with the working voltage. Analogously thereto, the wall elements 20, 20′ have a signal element 60, which serves to trigger the reversible transition from the braced position 100 into the open position 110. Compared to the state-of-the-art, in the inventive mobile partitioning wall 10, the voltage supply and the transmission of the unlocking signals are separated. A parallel voltage supply of the control units 40 is provided and in addition thereto a parallel disposed signal element 60, 60′ exists. Therefore, the control units 40 can be immediately supplied with a working voltage. It is only the signal element 60, 60′ transmits an unlocking signal to trigger a transition of a wall element 20, 20′ from the braced position 100 into the open position 110. It is moreover intended that unlocking the individual wall elements 20, 20′ is executed in the mobile partitioning wall 10 in a sequential manner. In order to guarantee the sequential process, after unlocking a first wall element 20, the signal element 60 generates a second unlocking signal for a second wall element 20′.

Unlocking a plurality of wall elements 20, 20′ of the mobile partitioning wall 10 is realized in a several steps. At first, the control units 40 of all the wall elements 20, 20′ are connected to electrical voltage source 50, in order to charge the control units 40 with a working voltage. As illustrated in FIG. 1, the two wall elements 20′, shown on the left hand side, are illustrated in braced position 100. They thus form a part of a continuous wall, which forms the mobile partitioning wall 10. Via contact elements 48, the electrical voltage source 50 is connected to conducting elements 49 which are disposed in each wall element 20, 20′. The control units 40 are connected in parallel between the conducting elements 49. In the closed position, the electrical voltage source 50 ensures that electrical voltage is supplied to all control units 40. Subsequently, a first unlocking signal is directed to a first wall element 20 via the signal elements 60 of the wall elements 20, 20′. The first unlocking signal triggers an activation of the control unit 40 in the first wall element 20. The activation by the first unlocking signal prompts the control unit 40 to energize the drive 35. The connecting profiles 30, braced between the floor and the ceiling, are thereby retracted such that the first wall element 20 moves into the open position 110. After the connecting profiles 30 are completely retracted, a second unlocking signal is generated for a second wall element 20′. This second unlocking signal is transmitted to the control unit 40 of the second wall element 20′ and triggers an activation of the drive 35.

As illustrated in FIG. 1, each of the wall elements 20, 20′ has a pin-and-socket connection 61, 62 which is disposed at one of the exterior sides—also referred to as the long sides—of the wall element 20, 20′. A pin element 62 of the respectively abutting wall element 20, 20′ engages in this pin-and-socket connection 61, 62. A continuous signal line 63, which interconnects the different signal elements 60, is thereby created within the mobile partitioning wall 10. Advantageously, the second unlocking signal is triggered by a movement of the first wall element 20. When the first wall element 20 moves in relation to the second wall element 20′, the pin element 62 is removed from the pin-and-socket connection 61. This separating of the pin-and-socket connection 61 from the pin element 62 may be registered by the signal element 60 and may lead to generating the second unlocking signal.

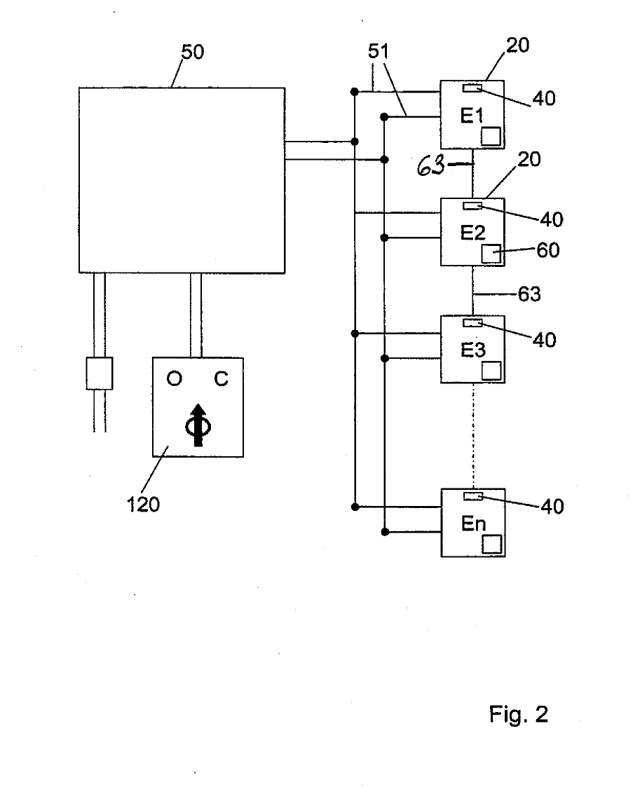

FIG. 2 shows a diagrammatical illustration of the parallel interconnected control units 40 of the different wall elements 20. Each of the wall elements E1, E2, E3, . . . EN has a respective control unit 40. These control units 40 are connected to an electrical voltage source 50 via a parallel connection. The electrical voltage source 50 is a wide-range input switched-mode power supply, which provides a voltage of about 40 volts for the control units 40. In order to be able to utilize the described mobile partitioning wall 10 worldwide, the electrical voltage source 50 can be operated at the most various voltages ranging from 120 to 230 volts, without having to change or modify the hardware. The individual signal elements 60 of the wall elements 20 are interconnected via a signal line 63. The signal line 63 extends parallel to the electrical supply of the control units 40. By separating the signal line 63 from the electrical supply 51 of the control units 40, the latter can be permanently supplied with a voltage. Consequently, only one electrical voltage source 50 is required to transfer even a plurality of wall elements 20, 20′ from the braced position 100 into the open position 110. In order to transfer the mobile partitioning wall 10 from the closed position into the open position, a switch unit 120 is provided.

The output voltage of the electrical voltage source 50 is 40 to 42 volts, wherein the control units 40 can operate in a range of 15 to 50 volts. Changing the direction of travel of the connecting profiles 30 can be produced by reversing the polarity of the voltage. Thereby, a reversible transition from the braced position 100 into the open position 110 and vice versa is made possible.

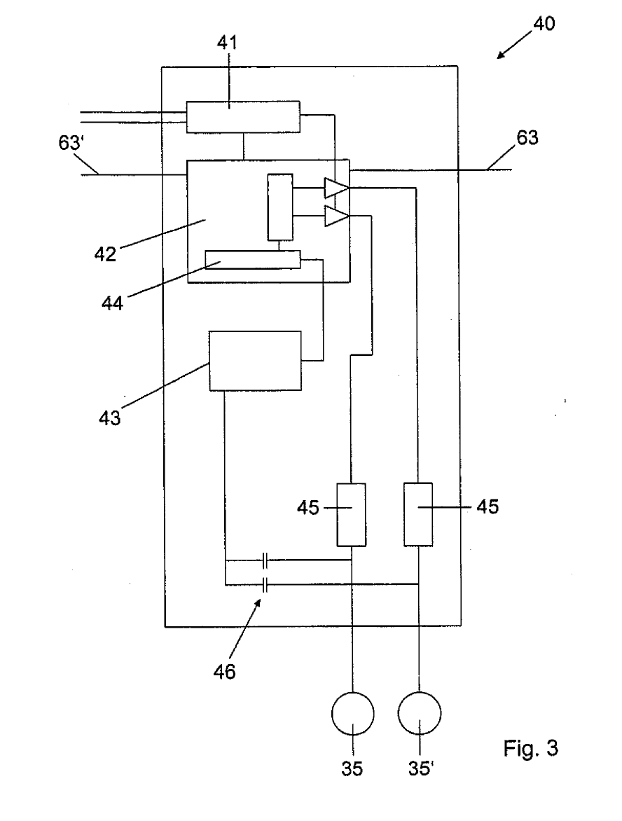

FIG. 3 illustrates the inventive control unit 40. The control unit 40 has a closed-loop circuit 41, which rectifies the input voltage to 12 and 5 volts and filters it. Moreover, a microcomputer 42 is incorporated into the control unit 40. This microcomputer 42 is connected to the signal line 63, 63′. The first unlocking signal is transmitted by the signal line 63. The first unlocking signal ensures that the connecting profiles 30 are retracted from the braced position 100. A software program may run on the microcomputer 42 for this purpose that analyzes the incoming first unlocking signal. A suitable electronic system activates relays 45, which ensure the operation of the motors 35, 35′. The connecting profiles 30, at the top and at the bottom of the wall element 20, are displaced by the two motors 35, 35′. Respectively one limit switch can be utilized to verify whether or not the connecting profiles 30 are completely braced between the floor and the ceiling or completely disposed at the wall element 20, 20′. As an alternative, FIG. 3 illustrates how the commutator malfunctions of the connected motors 35, 35′ are measured. A capacitor 46 realizes filtering the high-frequency commutator malfunction, which is monitored in a signal processing unit 43. If the signal of the commutator malfunctioning does not occur, the two relays 45 can be deactivated. An appropriate analog-to-digital converter 44 is incorporated into the control unit 40 for this task.

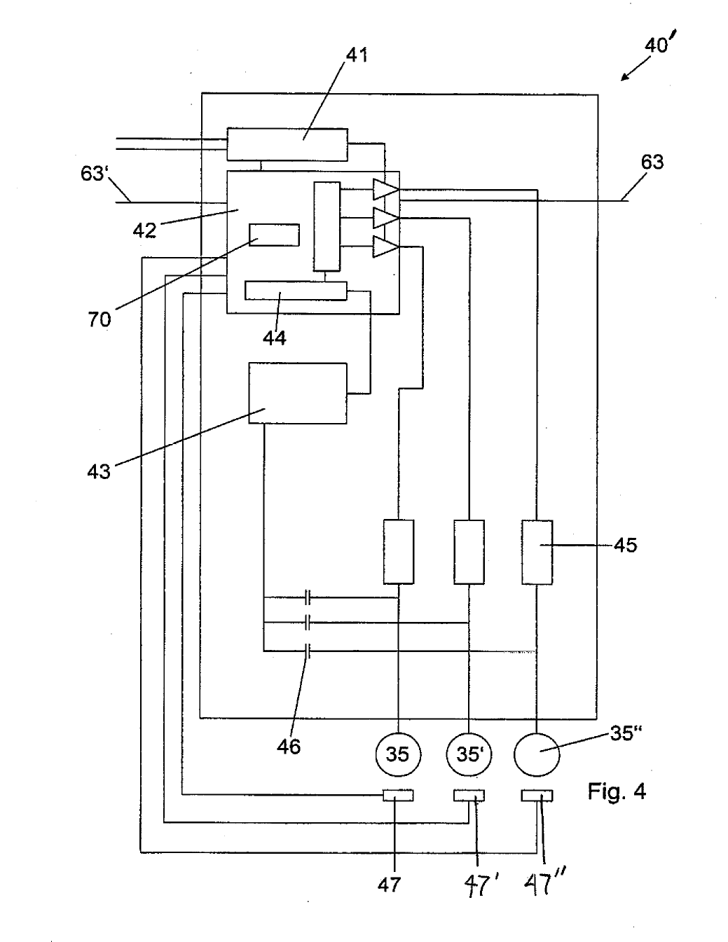

FIG. 4 illustrates another variant of the inventive control unit 40′. Unlike the control unit 40′ shown in FIG. 3, the control unit 40, shown in this case, has a monitoring system for three motors 35, 35′, 35″. The third drive 35″ may serve for example to laterally brace the wall element 20, 20′ against a wall. Moreover, a limit switch 47 is associated to each of the three drives 35, 35′, 35″. This limit switch 47 can monitor when the connecting profiles 30 reach an end position. Moreover, the control unit 40 has a multiple switch 70. Pre-programmed settings of the microcomputer 42 can be retrieved by this multiple switch 70. It is thus possible to utilize the control unit 40 for differently configured mobile partitioning walls 10. During installation, by the multiple switch 70, a technician can select the function for the control unit 40 among a plurality of operational sequences. By the selection switch 70, it is thus possible to determine how many drives 35, 35′, 35″ are to be activated in the current configuration of the mobile partitioning wall 10. Moreover, it can be selected whether or not limit switches or the commutator malfunction is to be monitored for the end position of the connecting profiles 30. The control unit 40 is thus modularly configured and can be adapted to the specific requirements on-site without having to exchange any hardware components.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. A mobile partitioning wall having a plurality of individually displaceable wall elements, wherein each wall element comprises:
vertically movable connecting profiles, wherein
in a braced position, the vertically movable connecting profiles are configured to be braced between a floor and a ceiling,
in an open position, the vertically movable connecting profiles are disposed at the wall element, and
when unlocking the mobile partitioning wall, the respective wall elements are sequentially transferable from the braced position into the open position;
at least one drive configured to drive the connecting profiles;
a control unit configured to control the at least one drive, the respective control units are connected in parallel to an electric voltage source such that, in the braced position, the control units are charged with a working voltage; and
a signal element configured to transmit a first unlocking signal configured to unlocking a first wall element and after unlocking the first wall element, the signal element generates a second unlocking signal for a second wall element.

16. The mobile partitioning wall according to claim 15, wherein the signal element comprises at least one pin-and-socket connection.

17. The mobile partitioning wall according to claim 16, wherein the signal element comprises at least one pin element, wherein the pin element of a first wall element cooperates with a pin-and-socket connection of a second adjacent wall element.

18. The mobile partitioning wall according to claim 15, wherein the control unit comprises a detector element configured to detect an activity of the at least one drive.

19. The mobile partitioning wall according to claim 18, wherein at least one of the signal element, the control unit, and the detector element analyses a commutator malfunction of the at least one drive.

20. A mobile partitioning wall according to claim 15, wherein the electrical voltage source is a wide-range input switched-mode power supply.

21. The mobile partitioning wall according to claim 15, wherein the control unit comprises a microcomputer configured as a programmable integrated circuit.

22. The mobile partitioning wall according to claim 15, wherein the control unit includes a multiple switch.

23. A method for unlocking a plurality of wall elements of a mobile partitioning wall, wherein each wall element includes vertically movable connecting profiles, a control unit and a signal element, the method comprising:
connecting the control units of each wall elements to an electrical voltage source to charge the control units with a working voltage;
transmitting a first unlocking signal is to a first wall element via the signal elements of the respective wall elements;
triggering an activation of the control unit of the first wall element by the first unlocking signal;
retracting of the connecting profiles, which are braced between the floor and the ceiling, under control of the control unit; and
generating a second unlocking signal for a second wall element once the retraction of the connecting profiles of the first wall element is completed.

24. The method according to claim 23, wherein the generating of the second unlocking signal is triggered by a movement of the first wall element in relation to the second wall element.

25. The method according to claim 23, wherein locking the plurality of wall elements of the mobile partitioning wall is triggered by reversing a polarity of the working voltage.

26. The method according to claim 23, wherein an activity of the drive is monitored by the control unit.

27. The method according to claim 23, wherein a supply unit of the drive is monitored to determine when the connecting profiles reach an end position.

28. The mobile partitioning wall according to claim 16, wherein the pin-and-socket connection is disposed at an exterior side of the wall element.

29. A mobile partitioning wall according to claim 22, wherein the multiple switch is a DIP-switch.

30. The method according to claim 26, wherein the activity of the drive is monitored by a sensor element of the control unit.
